(19) United States
(12) Patent Application Publication
(10) Pub. No.: US 2015/0296543 A1
(43) Pub. Date: Oct. 15, 2015

(54) METHOD FOR HANDLING CROSSING CALLS IN A COMMUNICATION NETWORK

(71) Applicant: TELEFONAKTIEBOLAGET L M ERICSSON (publ), Stockholm (SE)

(72) Inventors: Dionisis Voulgaris, Patras (GR); Yannis Kompostiotis, Patras (GR)

(21) Appl. No.: 14/438,966

(22) PCT Filed: Oct. 31, 2012
(86) PCT No.: PCT/EP2012/071620

§ 371 Date: Apr. 28, 2015

(51) Int. Cl. H04W 76/02; H04W 4/16

(52) U.S. Cl. CPC H04W 76/02; H04W 4/16; H04M 2207/18

(57) ABSTRACT

A method for handling crossing calls between a first and a second party in a communication network is disclosed. A first call between the first and the second party is disconnected. The first party attempts to establish a subsequent second call towards the second party. A number of the first party is stored in a database during establishment of the first call. It is further checked if a number of the first party attempting to establish the second call is the same with the number stored in the database and if the second party is attempting to establish a third call, simultaneous to the second call, towards the first party. In case both checks are positive, the second call is established towards the second party and the third call attempt is terminated.

### TECHNICAL FIELD

The present disclosure generally relates to handling of calls in case of simultaneous call attempts between two parties. The technique proposed by the invention may be implemented as a method, a computer program product, a device or a network system.

### BACKGROUND

In today's communication world, the evolution of mobile networks provides parties with the possibility to have good network coverage and manage to establish call connections with other parties without problems. Nevertheless, there are cases where call attempts fail. A common case where call attempts or calls fail is in case of lack of network coverage. Further examples of such failures and the reasons behind are described below.

In one example of a call failure is described in 3GPP TS 23.018 v11.2.0. During the paging procedure for a Mobile Terminated (MT) call the current call status of the called subscriber is requested. In case there is another call ongoing which is still in the setup phase and multicall supplementary service is either not provisioned or does not allow for multiple calls, paging will be rejected and this MT call will fail. A MT call is considered a call from the side of the called party, when the called party is the receiver of the call. Accordingly a Mobile Originated (MO) call is considered a call from the side of the calling party, when the calling party initiates the call.

Also according to the same TS, if a Connection Management (CM) Service Request is received in the Mobile Switching Center (MSC) serving the called party while a paging response is pending for an incoming call, the CM Service Request will take precedence and be processed in the MSC while the ongoing paging attempt will be aborted and the MT call will fail.

When a call between two mobile subscribers is terminated unexpectedly (i.e. the called is interrupted), there is a high chance that both parties involved in the terminated call will attempt to redial each other. These simultaneous call attempts will lead to a similar situation in both sides where the incoming MT call is crossed with the ongoing MO call attempt. If due to this call crossing, one of the scenarios described before then both MT call attempts will be rejected and as a result both calls will fail.

### SUMMARY

In general, there is a need for improving the handling of call in case of two parties simultaneously calling each other. This object is achieved by the independent claims. Advantageous embodiments are described in the dependent claims.

According to one embodiment, a method for handling calls between a first and a second party in a communication network is proposed. A first call between the first and the second party is terminated. The first party attempts to establish a second call towards the second party. A number of the first party is stored in a database during establishment of the first call. It is further checked if a number of the first party attempting to establish the second call is the same with the number stored in the database and if the second party is attempting to establish a third call towards the first party. In case both checks are positive, the second call is established towards the second party and the third call attempt is terminated.

In another embodiment, a control device for handling calls between a first and a second party in a communication network is proposed. A first call between the first and the second party is terminated. The first party attempts to establish a second call towards the second party. The control device comprises a database adapted to store a number of the first party during establishment of the first call. The device further comprises a controller adapted to check if a number of the first party attempting to establish the second call is the same with the number stored in the database. The controller is further adapted to check if the second party is attempting to establish a third call towards the first party. The control device further comprises a switch adapted to establish the second call towards the second party and terminate the third call attempt in case both checks performed by said controller are positive.

### BRIEF DESCRIPTION OF THE DRAWINGS

Further aspects, details and advantages of the invention presented herein will become apparent from the following description of exemplary embodiments in conjunction with the drawings, wherein:

FIG. 1 shows a graphical overview of the proposed invention;

FIG. 2 shows a control device adapted to implement the proposed method.

### DETAILED DESCRIPTION

In the following description of exemplary embodiments, for purposes of explanation and not limitation, specific details are set forth like specific flowcharts or architectural diagrams in order to provide a thorough understanding of the invention presented herein. It can be apparent to one skilled in the art that the invention may be practised in other embodiments that depart from these specific details.

Moreover, those skilled in the art will appreciate that the services, functions and steps explained herein may be implemented using software functioning in conjunction with a programmed microprocessor, an Application Specific Integrated Circuit (ASIC), a Digital Signal Processor (DSP) or a general purposes computer. It will also be appreciated that while the following embodiments will primarily be described in the context of methods and devices, the technique presented herein may also be embodied in a computer program product as well as in a system comprising a computer processor and a memory coupled to the processor, wherein the memory is encoded with one or more programs that may be adapted to perform the services, functions and steps disclosed herein.

The invention described below is generally directed to enabling a call between two parties to be established in case the two parties are calling each other simultaneously.

In order to overcome the problem of both calls failing, the storing of the last calling party number in the VLR every time a MT call is established for a mobile subscriber is proposed.

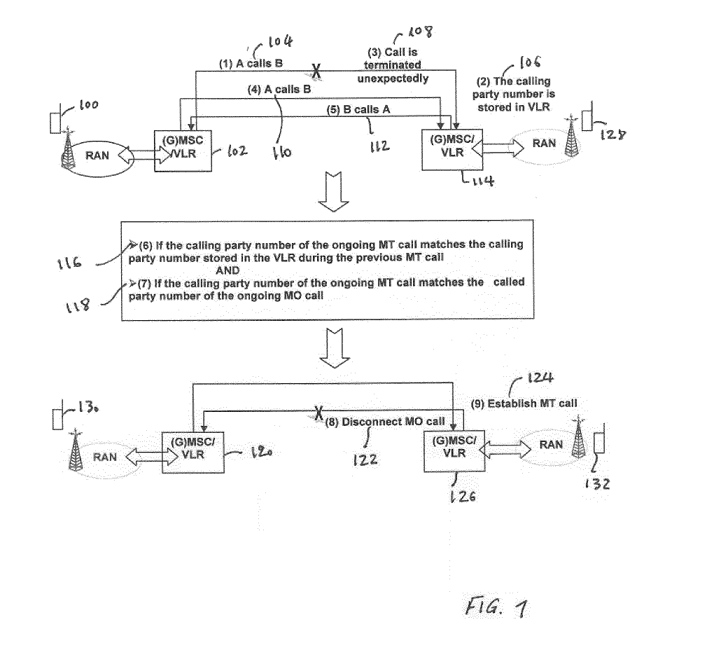

FIG. 1 shows a graphical overview of the proposed invention. When one of the scenarios described above occurs, before rejecting the MT call attempt, a check is performed in order to compare the current calling party number with the current called party number and also the last calling party number stored during the preceding MT call. If these values are equal then the paging request for the MT call will be allowed to proceed, while at the same time the disconnection of the ongoing MO call setup will be ordered.

In more detail, it is assumed that a calling party A 100 calls a called party B 128. Calling party A 100 can be considered a first party and called party B 128 can be considered a second party in the scenario described. The number of the calling party is stored 106 by the MSC 102 in the Visitor Location Register (VLR) 102 which is part of the MSC 102 serving the called party. The VLR 102 can be considered a database keeping a record of the parties or subscribers who are roaming in the jurisdiction of the MSC that it serves. Normally the call is successful and it is established between parties A and B which can also be referred to as calling and called subscribers. Following a successful establishment of the call, for reasons described above or other reasons, at some point the call is terminated unexpectedly 108 and without the wish of the involved parties.

As happens often in that case, calling party A attempts to establish a new call 110 towards called party B and at the same time, party B tries to establish a call 112 towards party A. in that case, the call that calling party A attempts to establish towards party B is a MT call for party B. Also the call that party B attempts to establish towards party A is a MO call for party B. During the paging procedure for the MT call, if party B is involved in a MO call which is still in setup phase, then before providing a negative response to the paging request the following checks described below are performed.

The first check 116 is performed to compare the calling party number of the ongoing MT call (number of party A) with the calling party number stored in the VLR during the previous MT call. The second check 118 is performed to confirm that the called (or B) party is indeed attempting to establish a call towards the calling (or A) party. This is achieved by checking if the calling party number of the ongoing MT call matches the called party number of the ongoing MO call. The sequence of the checks is not crucial for the invention and can be performed in any sequence. Therefore the terms first and second check are used only for descriptive reasons.

If the first check result is positive, i.e. if indeed the two numbers are the same, the calling subscriber or party of the ongoing MT call matches the calling subscriber or party of the previous MT call. If the second check result is also positive, the calling subscriber of the ongoing MT call also matches the called subscriber of the ongoing MO call.

In case both of the check results are positive then the MSC will proceed with the establishment of the MT call 124. At the same time the rejection of the ongoing MO call will be triggered 122. This is done to avoid both calls being established at the same time resulting to a potential subsequent termination of both calls. A paging request will not be sent but instead the MT call will use the existing connection established between the mobile station of the calling party and the network during the initiation of the ongoing MO call procedure.

If the comparison of the calling party number of the ongoing MT call (number of party A) with the calling party number stored in the VLR reveals that these numbers are different then the number stored in the VLR is overwritten by the number of the calling party of the ongoing MT call. If the ongoing MO call is not rejected and is established between the two parties then the number stored in the VLR is deleted.

In case the MSC is waiting for a paging response from the mobile station when a CM Service Request is received from the same subscriber then before terminating the paging procedure in order to give precedence to the ongoing MO call the same two checks as above are performed. In case both of these check results are positive then the MSC will reject the CM Service Request and will continue waiting for a paging response.

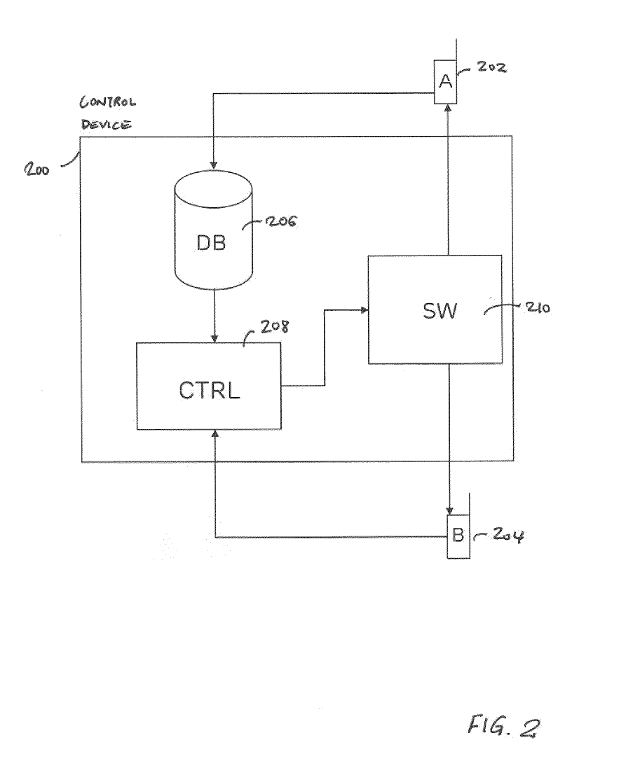

FIG. 2 shows a control device 200 adapted to implement the proposed method. It is assumed that a first call between the first (or calling) and the second (or called) party is terminated. In that case the calling party would be party A 202 using a mobile device A as shown in the figure. The called party would be party B 204 using a mobile device B as shown in the figure. The calling party attempts to establish another (or second) call towards the called party. The device comprises a database 206 which is adapted to store a number of the calling party during establishment of the first call. The device further comprises a controller 208 which is adapted to check if the number of the calling party attempting to establish the second call is the same with the number stored in the database. This check has the purpose to validate if the calling party is the same for both the first and the second calls.

The controller is further adapted to check if the called party is attempting to establish yet another (or a third) call towards the first party. This check has the purpose to validate if indeed the called party tries to call the calling party and not another party.

The control device finally comprises a switch 210 which is adapted to establish the second call towards the second party and terminate the third call attempt in case both checks performed by the controller as described above are positive.

The control device can be implemented as part of a node in a telecommunication network like for example a MSC.

It is believed that many advantages of the invention described are fully understood from the provided description. It will be apparent though that various changes may be made in the form, construction, and arrangement of the exemplary embodiments without departing from the scope of the invention, or without sacrificing all of its advantages. Because the invention presented can be varied in many ways, it will be recognized that the invention should be limited only by the scope of the claims that follow.

1. A method for handling calls between a first and a second party in a communication network wherein a first call between the first and the second party is terminated, the first party attempting to establish a second call towards the second party, the method comprising the steps of:
storing a number of the first party during establishment of the first call in a database,
checking if a number of the first party attempting to establish the second call is the same as the number stored in the database,
checking if the second party is attempting to establish a third call towards the first party, and
responsive to determining that the number of the first party attempting to establish the second call is the same as the number stored in the database and responsive to determining that the second party is attempting to establish the third call towards the first party, establishing the second call towards the second party and terminating the third call attempt.

2. The method of claim 1, wherein based on the number of the first party attempting to establish the second call being different from the number stored in the database, overwriting the number stored in the database by a number of the first party.

3. The method of claim 1, wherein based on the second party establishing a fourth call towards the first party, deleting the number stored in the database.

4. The method of any of claim 1 wherein the database is a visitor location register.

5. The method of claim 1, wherein the attempt to establish the third call is simultaneous to the attempt to establish the second call.

6. A control device for handling calls between a first and a second party in a communication network wherein a first call between the first and the second party is terminated, the first party attempting to establish a second call towards the second party, the control device comprising:
a database adapted to store a number of the first party during establishment of the first call, and
a controller adapted to check if a number of the first party attempting to establish the second call is the same as the number stored in the database, to check if the second party is attempting to establish a third call towards the first party, the control device further comprising:
a switch adapted to establish the second call towards the second party and terminate the third call attempt responsive to determining that the number of the first party attempting to establish the second call is the same as the number stored in the database and responsive to determining that the second party is attempting to establish the third call towards the first party.

7. (canceled)

8. (canceled)

9. The control device of claim 6, wherein the switch is further adapted to, based on the number of the first party attempting to establish the second call being different from the number stored in the database, overwrite the number stored in the database by a number of the first party.

10. The control device of claim 6, wherein the switch is further adapted to, based on the second party establishing a fourth call towards the first party, delete the number stored in the database.

11. The control device of claim 6, wherein the database is a visitor location register.

12. The control device of claim 6, wherein the attempt to establish the third call is simultaneous to the attempt to establish the second call.

13. A computer program product comprising:
a non-transitory computer readable storage medium having computer readable program code embodied therewith, the computer readable program code when executed by a processor causes the processor to perform operations comprising:
storing a number of the first party during establishment of the first call in a database,
checking if a number of the first party attempting to establish the second call is the same as the number stored in the database,
checking if the second party is attempting to establish a third call towards the first party, and
responsive to determining that the number of the first party attempting to establish the second call is the same as the number stored in the database and responsive to determining that the second party is attempting to establish the third call towards the first party, establishing the second call towards the second party and terminating the third call attempt.

14. The computer program product of claim 13, wherein the operation further comprise:
overwriting the number stored in the database by a number of the first party based on the number of the first party attempting to establish the second call being different from the number stored in the database.

15. The computer program product of claim 13, wherein the operation further comprise:
deleting the number stored in the database based on the second party establishing a fourth call towards the first party.

16. The computer program product of claim 13, wherein the database is a visitor location register.

17. The computer program product of claim 13, wherein the attempt to establish the third call is simultaneous to the attempt to establish the second call.
